(19) United States
(12) Patent Application Publication
(10) Pub. No.: US 2023/0178753 A1
(43) Pub. Date: Jun. 8, 2023

(54) POSITIVE ELECTRODE, ELECTRODE BODY, AND BATTERY

(71) Applicant: Prime Planet Energy & Solutions, Inc., Tokyo (JP)

(72) Inventors: Hidemasa KAWAI, Himeji-shi (JP); Keisuke OTA, Tokyo (JP); Kazuhiro MAEDA, Himeji-shi (JP); Haruya NAKAI, Toyonaka-shi (JP); Taiki NONAKA, Kakogawa-shi (JP)

(21) Appl. No.: 18/059,438

(22) Filed: Nov. 29, 2022

(30) Foreign Application Priority Data
Dec. 2, 2021 (JP) 2021-196261

(51) Int. Cl. H01M 4/66; H01M 4/13

(52) U.S. Cl. CPC H01M 4/667; H01M 4/13; H01M 2004/028

(57) ABSTRACT

The positive electrode disclosed herein includes a positive electrode current collector foil, positive electrode active material layers disposed on both surfaces of the current collector foil, a first protection layer disposed adjacent to the positive electrode active material layer on one surface of the current collector foil. The current collector foil has an exposed portion in which the current collector foil is exposed, at least at one end. The first protection layer is located between the exposed portion and the positive electrode active material layer. The first protection layer has an inclined portion in which a thickness of the first protection layer decreases from the positive electrode active material layer side toward the exposed portion. The inclined portion is configured so that an angle to the surface of the current collector foil is constant or decreases toward the exposed portion.

### CROSS REFERENCE TO RELATED APPLICATIONS

The present application is based upon and claims the benefit of priority from Japanese patent application No. 2021-196261 filed on Dec. 2, 2021, and the entire disclosure of which is incorporated herein its entirety by reference.

### BACKGROUND

The present disclosure relates to a positive electrode, an electrode body, and a battery.

An electrode body used in a battery includes, for example, a sheet-like positive electrode and a sheet-like negative electrode stacked via a separator. Typically, the positive and negative electrodes each have a metal-made current collector foil and an active material layer provided thereon. The positive and negative electrodes are each provided with current collector foil exposed portions at its end, and the current collector foil exposed portions stacked are bundled and welded in each of the positive and negative electrodes. For example, Japanese Patent Application Publication No. 2017-4846 discloses, as a current collector foil exposed portion, an electrode having tabs in a shape protruding from one side of a current collector foil, and further discloses a technology of gathering and welding the stacked tabs along the stacking direction in an electrode assembly including the electrodes stacked. Japanese Patent Application Publication No. 2019-207794 discloses a technology of gathering current collector tabs by using a tape.

### SUMMARY

A current collector foil exposed portion (e.g., a current collector tab) is a portion in which a thin metal foil is exposed, and thus tends to be wrinkled, bent, and broken at the time of transportation and processing (e.g., welding of the current collector foil exposed portion) of the electrodes (the positive and negative electrodes). According to the study by the present inventors, it was found that the cause of this is a variation in direction of inclination of the current collector foil exposed portion.

The present disclosure was made in view of the circumstances, and is intended to provide a positive electrode in which inclination of the current collector foil exposed portion is controlled. Other objects of the present disclosure are to provide an electrode body including the positive electrode and a battery including the electrode body.

The present inventors focused on a protection layer provided on a positive electrode current collector foil exposed portion of a positive electrode active material layer to control inclination of the current collector foil exposed portion. The protection layer in a positive electrode usually has a function of preventing short circuit between positive and negative electrodes. The present inventors have conducted earnest studies on the shape of the protection layer in order for the protection layer to have an additional function.

The positive electrode disclosed herein includes: a positive electrode current collector foil; positive electrode active material layers disposed on both surfaces of the positive electrode current collector foil; and a first protection layer disposed adjacent to one of the positive electrode active material layers on one surface of the positive electrode current collector foil. The positive electrode current collector foil has a positive electrode current collector foil exposed portion in which the positive electrode current collector foil is exposed, at least at one end. The first protection layer is located between the positive electrode current collector foil exposed portion and the positive electrode active material layer. The first protection layer has an inclined portion. The inclined portion has a thickness of the first protection layer decreasing from the positive electrode active material layer side toward the positive electrode current collector foil exposed portion. An angle of the inclined portion to the surface of the positive electrode current collector foil is constant or decreases toward the positive electrode current collector foil exposed portion.

The positive electrode has an inclined portion configured so that the angle of the first protection layer to the surface of the positive electrode current collector foil is constant or decreases toward the positive electrode current collector foil exposed portion. Such a configuration is derived from the shape of a first protection layer forming paste applied on the surface of the positive electrode current collector foil. When the applied forming paste with such a shape is dried, the first protection layer forming paste applied to the positive electrode current collector foil exposed portion side of the inclined portion is contracted toward the direction of the thickness of the paste (the positive electrode active material layer side). At this time, the direction of the force of contraction of the paste has an acute angle to the surface of the positive electrode current collector foil. Thus, when the applied first protection layer forming paste is dried, the positive electrode current collector foil exposed portion is strained toward the direction of the acute angle. This allows inclination of the positive electrode current collector foil exposed portion to the surface where the first protection layer is formed, and allows control of the direction if inclination of the positive electrode current collector foil exposed portion.

In an aspect of the positive electrode disclosed herein, a second protection layer disposed between the positive electrode active material layer and the positive electrode current collector foil exposed portion on a surface of the positive electrode current collector foil opposite to the surface where the first protection layer is formed. An average thickness of the inclined portion of the first protection layer is larger than an average thickness of a portion of the second protection layer corresponding to the position of the inclined portion. This further increases an inclination force toward the first protection layer than the second protection layer, and makes it easier to suitably control the direction of inclination of the positive electrode current collector foil exposed portion.

In an aspect of the positive electrode disclosed herein, in a cross section of the first protection layer along an inclination direction of the inclined portion, a maximum thickness Tₘₐₓ of the inclined portion in the first protection layer is two times or more larger than a minimum thickness Tₘᵢₙ of the inclined portion in the first protection layer. The larger the difference between the above maximum thickness Tₘₐₓ and the above minimum thickness Tₘᵢₙ, the larger the angle to the surface of the cathode current collector foil of the force of the paste shrinking at the minimum thickness Tₘᵢₙ when the coated first protective layer forming paste is dried, and the more easily the exposed portion of the cathode current collector foil can be inclined.

The present disclosure further provides an electrode body including the positive electrode disclosed herein and a negative electrode. In the electrode body, the direction of the positive electrode current collector foil exposed portion can be adjusted arbitrary. This allows reduction in load to bundle the positive electrode current collector foil exposed portion and prevention of wrinkle and breakage.

The present disclosure can provide a battery including the electrode disclosed herein. In such a battery, wrinkle and breakage of the positive electrode current collector foil exposed portion are substantially prevented. This allows reliability of the quality of the battery to be enhanced.

### BRIEF DESCRIPTION OF THE DRAWINGS

FIG. 1 is a schematic cross-sectional view of a configuration of a battery according to an embodiment.

FIG. 2 is a schematic exposed view of the configuration of an electrode body of the battery according to the embodiment.

FIG. 3A is a schematic view of a configuration of a positive electrode according to the embodiment near a positive electrode current collector foil exposed portion after a first protection layer forming paste is applied and before the paste is dried.

FIG. 3B is a schematic view of the configuration of the positive electrode according to the embodiment near the positive electrode current collector foil exposed portion.

FIG. 4 is a schematic view of an example of a method of producing the positive electrode according to the embodiment.

FIG. 5 is a cross-sectional view of a stacking surface of a wound electrode body including the positive electrode according to the embodiment.

FIG. 6 is a schematic exposed view of the configuration of an electrode body of a battery according to another embodiment.

FIG. 7 is a schematic view of the configuration of a positive electrode according to a first variation, which corresponds to FIG. 3A.

FIG. 8 is a schematic view of the configuration of a positive electrode according to a second variation, which corresponds to FIG. 3A.

FIG. 9 is a schematic view of the configuration of a positive electrode according to a third variation, which corresponds to FIG. 3A.

### DETAILED DESCRIPTION

The technology disclosed herein will be described below. The matters necessary for executing the present disclosure, except for matters specifically herein referred to can be grasped as design matters of those skilled in the art based on the related art in the preset field. The technology disclosed herein can be executed based on the contents disclosed herein and the technical knowledge in the present field.

Each drawing is illustrated schematically, and the dimensional relation (such as length, width, or thickness) in each drawing does not necessarily reflect the actual dimensional relation. In the drawings described below, the same members/portions which exhibit the same action are denoted by the same reference numerals, and the duplicated descriptions may be omitted or simplified.

The expression “A to B (here A and B are any numerical values)” indicating herein a numerical range means “A or more to B or less,” and also means “above A to less than B,” “above A to B or less,” and “A or more to less than B.”

The “battery” herein is a term that indicates all electricity storage devices capable of extracting electric energy, and is a concept that encompasses primary batteries and secondary batteries. The “secondary battery” herein is a term that indicates all electricity storage devices that can be repeatedly charged and discharged, and is a concept that encompasses so-called secondary batteries (chemical batteries) such as a lithium-ion secondary battery and a nickel hydrogen battery and capacitors (physical batteries) such as an electric double layer capacitor.

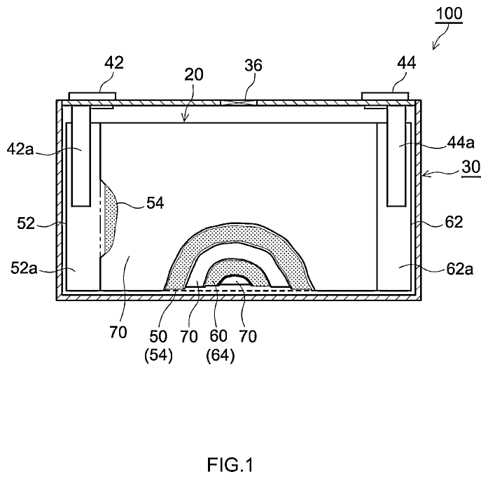

FIG. 1 is a schematic cross-sectional view of the configuration of a battery 100 according to an embodiment. The battery 100 is a square sealed battery constructed by housing a flat electrode body (wound electrode body) 20 and a nonaqueous electrolyte (not shown) in a battery case 30. The battery 100 herein is a lithium-ion secondary battery. The battery case 30 is provided with a positive electrode terminal 42 and a negative electrode terminal 44 for external connection. The battery case 30 is further provided with a thin-walled safety valve 36 set so that the internal pressure of the battery case 30 is released when it reaches a predetermined level or higher. The battery case 30 is further provided with an inlet (not shown) for introducing the nonaqueous electrolyte. The material of the battery case 30 is preferably a metal material which has high strength, is light, and has good thermal conductivity. Examples of such a metal material include aluminum and steel.

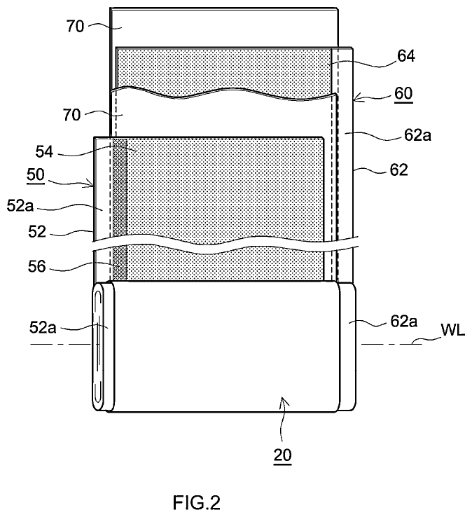

FIG. 2 is a schematic exposed view of the configuration of the electrode body 20 of the battery 100 according to the embodiment. As shown in FIG. 2, the electrode body 20 is a wound electrode body obtained by stacking a positive electrode 50 having a long sheet shape and a negative electrode 60 having a long sheet shape via two separators 70 having a long sheet shape and winding the resultant laminate around a winding axis WL. Although described in detail later, the positive electrode 50 includes a positive electrode current collector foil 52, positive electrode active material layers 54 formed on both longitudinal surfaces of the positive electrode current collector foil 52, and a first protection layer 56 formed adjacent to the positive electrode active material layers 54. In one edge (end) of the positive electrode current collector foil 52 in the winding axis WL direction (i.e., a sheet width direction orthogonal to the longitudinal direction), a portion (i.e., the positive electrode current collector foil exposed portion 52a) where the positive electrode active material layers 54 are not formed along the edge and the positive electrode current collector foil 52 is exposed is provided. The first protection layer 56 is located between a positive electrode current collector foil exposed portion 52a and the positive electrode active material layers 54. The negative electrode 60 includes a negative electrode current collector foil 62 and negative electrode active material layers 64 formed on one of or both (here both) longitudinal surfaces of the negative electrode current collector foil 62. In the other edge on one side of the negative electrode current collector foil 62 in the winding axis WL direction, a portion (i.e., a collector foil exposed portion 62a) where a strip-like negative electrode active material layer 64 is not formed along the edge and the negative electrode current collector foil 62 is exposed is provided. A positive electrode current collector 42a is bonded to the positive electrode current collector foil exposed portion 52a, and a negative electrode current collector 44a is bonded to the negative electrode current collector foil exposed portion 62a (see FIG. 1). The positive electrode current collector 42a is in electrical connection with the positive electrode terminal 42 for external connection, which provides conductivity between the inside and outside of the battery case 30. Similarly, the negative electrode current collector 44a is in electrical connection with the negative electrode terminal 44 for external connection, which provides conductivity between the inside and outside of the battery case 30 (see FIG. 1). A current interrupt device (CID) may be installed between the positive electrode terminal 42 and the positive electrode current collector 42a or between the negative electrode terminal 44 and the negative electrode current collector 44a.

Examples of the positive electrode current collector foil 52 constituting the positive electrode 50 include an aluminum foil. The positive electrode active material layer 54 contains a positive electrode active material. The positive electrode active material used may be a known positive electrode active material used in a lithium-ion secondary battery, and examples thereof include lithium composite metal oxides having a layered structure, a spinel structure, an olivine structure, and the like (e.g., LiNi_{1/3}Co_{1/3}Mn_{1/3}O₂, LiNiO₂, LiCoO₂, LiFeO₂, LiMn₂O₄, LiNi_{0.5}Mn_{1.5}O₄, LiCrMnO₄, and LiFePO₄). The positive electrode active material layer 54 may further contain an electroconductive material, a binder, and the like. The electroconductive material used may be, for example, carbon black such as acetylene black (AB) and other carbon materials (such as graphite). The binder used may be, for example, polyvinylidene fluoride (PVDF).

The positive electrode active material layer 54 can be formed by dispersing a positive electrode active material and optional materials (an electroconductive material, a binder, and the like) used if necessary, in an appropriate solvent (e.g., N-methyl-2-pyrrolidone (NMP), forming the resultant into a paste (or slurry) composition, applying an appropriate amount of the composition to the surface of a positive electrode current collector foil 52, and then drying the composition.

Examples of the negative electrode current collector foil 62 constituting the negative electrode 60 include a copper foil. The negative electrode active material layer 64 contains a negative electrode active material. Examples of the negative electrode active material used include carbon materials such as graphite, hard carbon, and soft carbon. The negative electrode active material layer 64 may further contain a binder, a thickener, and the like. Examples of the binder used include styrene-butadiene rubber (SBR). Examples of the thickener used include carboxymethyl cellulose (CMC).

The negative electrode active material layer 64 can be formed by dispersing a negative electrode active material and optional materials (a binder and the like) used if necessary, in an appropriate solvent (e.g., ion-exchange water), forming the resultant into a paste (or slurry) composition, applying an appropriate amount of the composition to the surface of a negative electrode current collector foil 62, and then drying the composition.

The separator 70 used may be any of various microporous sheets which are similar to those which have been used in a lithium-ion secondary battery, and examples thereof include microporous resin sheets made of resin such as polyethylene (PE) and polypropylene (PP). Such a microporous resin sheet may have a monolayer structure, or a lamination structure of two or more layers (e.g., a three-layer structure where PP layers are stacked on both surfaces of a PE layer). The separator 70 may include a heat-resistance layer (HRL).

The nonaqueous electrolyte used may be any of those which are similar to those used in a lithium-ion secondary battery, and examples thereof include nonaqueous electrolytes obtained by causing an organic solvent (nonaqueous solvent) to contain a supporting electrolyte. The nonaqueous solvent used may be any of aprotic solvents such as carbonates, esters, and ethers. Among them, carbonates such as ethylene carbonate (EC), dimethyl carbonate (DEC), dimethyl carbonate (DMC), and ethyl methyl carbonate (EMC) may be suitably employed. Alternatively, fluorine-based solvents such as fluorinated carbonates, namely monofluoro ethylene carbonate (MFEC), difluoro ethylene carbonate (DFEC), monofluoromethyl difluoromethyl carbonate (F-DMC), and trifluoro dimethyl carbonate (TFDMC) may be preferably used. These nonaqueous solvents may be used alone or in combination of two or more of them, as appropriate. Examples of the supporting electrolyte used include lithium salts such as LiPF₆, LiBF₄, and LiClO₄. The concentration of the electrolyte salt is not particularly limited, and is preferably approximately 0.7 mol/L or more to 1.3 mol/L or less.

The nonaqueous electrolyte may further contain, for example, various additives such as a gas generator, a film-forming agent, a dispersant, and a thickener, besides the nonaqueous electrolyte and the supporting electrolyte, as long as the effect of the present disclosure is not significantly impaired.

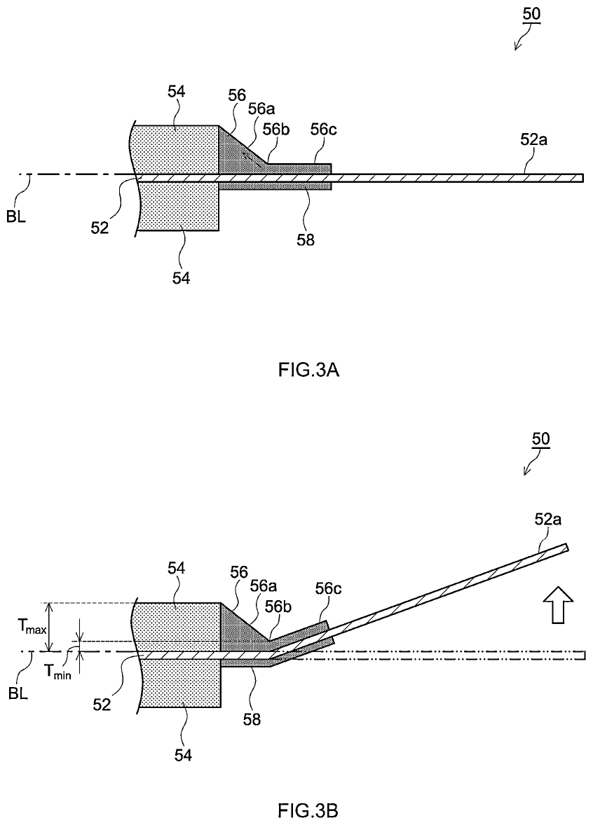

FIG. 3A is a schematic view of a configuration of the positive electrode 50 according to the embodiment near the positive electrode current collector foil exposed portion 52a after a first protection layer forming paste is applied and before the paste is dried. FIG. 3B is a schematic view of the configuration of the positive electrode 50 according to the embodiment near the positive electrode current collector foil exposed portion 52a. FIG. 3A shows the configuration (the positive electrode precursor) before the applied paste is dried, but shows a reference sign corresponding to the reference sign of the positive electrode 50 for explanation. FIGS. 3A and 3B show the cross section of the positive electrode 50 along a direction of inclination of the inclined portion 56a of the first protection layer 56 to be described later. In other words, FIGS. 3A and 3B show the cross section shown when the positive electrode 50 is cut orthogonal to the longitudinal direction of the positive electrode current collector foil 52. Hereinafter, “the cross section of the positive electrode” refers to that cross section.

As shown in FIG. 3B, in the present embodiment, the positive electrode 50 includes a positive electrode current collector foil 52, a positive electrode active material layer 54, a first protection layer 56, and a second protection layer 58. The positive electrode current collector foil exposed portion 52a is inclined toward the surface on which the first protection layer 56 is formed. The second protection layer 58 is not a necessary component and may be omitted in other embodiments.

The first protection layer 56 is formed (disposed) adjacent to the positive electrode active material layer 54. The first protection layer 56 has an inclined portion 56a formed so that its thickness decreases from the positive electrode active material layer 54 side toward the positive electrode current collector foil exposed portion 52a, a flat portion 56c formed closer to the positive electrode current collector foil exposed portion 52a than the inclined portion 56a, and an inclination guiding portion 56b in a boundary between the inclined portion 56a and the flat portion 56c.

A method of producing the positive electrode 50 disclosed herein includes: applying a first protection layer forming paste (hereinafter also referred to as “applying”) and drying the first protection layer forming paste applied (hereinafter also referred to as “drying,” for example.

In the applying, as shown in FIG. 3A, the first protection layer forming paste is applied so that the inclined portion 56a and the flat portion 56c are formed. In this embodiment, the inclined portion 56a is formed to have a constant angle to the surface of the positive electrode current collector foil 52 (the base line BL in FIG. 3A). The angle is not particularly limited, and can be, for example, 10° to 80°, 20° to 70°, 30° to 60°, 40° to 50°. The angle refers to an angle in the cross section of the positive electrode shown in FIG. 3A.

In the present embodiment, in the first protection layer 56, the inclination guiding portion 56b is present in the boundary between the inclined portion 56a with a certain angle and the flat portion 56c. In other words, in the cross section of the positive electrode 50, the angle of the surface of the first protection layer 56 to the surface of the positive electrode current collector foil 52 changes at the inclination guiding portion 56b. The first protection layer 56 includes an inclined portion 56a. Thus, when the applied first protection layer forming paste is dried, the force of contraction of the first protection layer forming paste in the inclined portion 56a is directed toward the center of the inclined portion 56a. Specifically, a force of contraction toward the positive electrode active material layer 54 with a larger thickness is applied to the first protection layer forming paste located on the positive electrode current collector foil exposed portion side of the inclined portion 56a. At this time, the direction of the force of the contraction has an acute angle to the surface of the positive electrode current collector foil 52 (see an arrow in FIG. 3A). Thus, when the first protection layer forming paste is dried and contracted, the positive electrode current collector foil exposed portion 52a is strained toward the direction of the acute angle. This allows the positive electrode current collector foil exposed portion 52a to be inclined toward the surface on which the first protection layer 56 is formed, starting from the portion where the first protection layer 56 is formed (see an arrow in FIG. 3B).

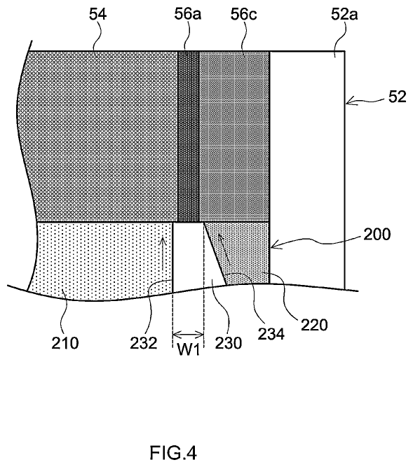

FIG. 4 is a schematic view of an example of a method of producing the positive electrode 50 according to the embodiment. FIG. 4 schematically shows how to apply the positive electrode active material layer forming paste and the first protection layer forming paste to the surface of the positive electrode current collector foil 52 by using a die head 200. The shape of the first protection layer 56 can be generally determined at the time when the first protection layer forming paste is applied.

The die head 200 includes an active material layer forming paste outlet 210, a protection layer forming paste outlet 220, and a partition 230 partitioning these outlets. The active material layer forming paste outlet 210 is filled with a positive electrode active material layer forming paste, and the protection layer forming paste outlet 220 is filled with the first protection layer forming paste. Here, a side wall 232 of the partition 230 on the active material layer forming paste outlet 210 side is configured to be parallel with the longitudinal direction (the up-down direction in FIG. 4) of the positive electrode current collector foil 52. Here, a side wall 234 of the partition 230 on the protection layer forming paste outlet 220 side is configured to have an acute angle (e.g., 5° to 50°, preferably 10° to) 30° to the side wall 232 on the active material layer forming paste outlet 210 side. The die head 200 simultaneously ejects the positive electrode active material layer forming paste and the first protection layer forming paste. With such a configuration, the first protection layer forming paste is ejected so as to collide on the positive electrode active material layer forming paste on the positive electrode current collector foil 52 (see an arrow in FIG. 4). Accordingly, in a portion where the first protection layer forming paste and the positive electrode active material layer forming paste collide on each other, the first protection layer forming paste is applied to rise, thereby forming an inclined portion 56a.

By adjusting the width W1 of the partition 230 at the end of the outlet of the die head 200, the shape of the inclined portion 56a of the first protection layer 56 can be adjusted. Although not particularly limited thereto, the width W1 of the partition 230 is, for example, 0 μm to 3000 μm, preferably 400 μm to 1000 μm. When the width W1 of the partition 230 is 1000 μm or less, the first protection layer forming paste and the positive electrode active material layer forming paste easily collide on each other on the positive electrode current collector foil 52, and the inclined portion 56a can be stably formed. In light of the strength of the partition 230, the width W1 of the partition 230 may be 400 μm or more. When the width W1 of the partition 230 is 0 μm, the side wall 232 of the partition 230 on the active material layer forming paste outlet 210 side and the side wall 234 of the partition 230 on the protection layer forming paste outlet 220 side are in direct contact with each other at the end of the outlet (i.e., the end of the partition 230 is sharp).

The drying can be performed by a known method, and the drying temperature and the drying time can be determined, as appropriate, according to the amounts of the solvent contained in the positive electrode active material layer forming paste and the first protection layer forming paste. Although not particularly limited thereto, the drying temperature may be, for example, 70° C. to 200° C. The drying time may be, for example, 20 seconds to 120 minutes.

In the positive electrode 50 formed as described above, as shown in FIG. 3B, the positive electrode current collector foil exposed portion 52a is inclined toward the first protection layer 56. Although not particularly limited thereto, the angle of inclination is, for example, 5° to 40°, preferably 15° to 30°. The angle of inclination refers to an angle to the surface of the positive electrode current collector foil 52 where the positive electrode active material layer 54 is formed (to the base line BL in FIG. 3B).

The angle of the inclined portion 56a of the first protection layer 56 to the surface of the positive electrode current collector foil 52 (the angle to the base line BL in FIG. 3B) may be the same as the angle of the inclined portion 56a in the applying, and may be, for example, 10° to 80°, 20° to 70°, 30° to 60°, and 40° to 50°.

In the cross section of the positive electrode 50 along the direction in which the inclined portion 56a of the first protection layer 56 is inclined, the maximum thickness Tₘₐₓ of the inclined portion 56a in the first protection layer 56 may be preferably two times larger than, more preferably 2.5 times larger than, yet more preferably 3 times larger than the minimum thickness Tₘᵢₙ of the inclined portion 56a in the first protection layer 56. The larger the difference between the maximum thickness Tₘₐₓ and the minimum thickness Tₘᵢₙ, the larger the angle of the force of contraction of the first protection layer forming paste at the minimum thickness Tₘᵢₙ at the time when the paste applied is dried to the surface of the positive electrode current collector foil 52. This makes it easier for the positive electrode current collector foil exposed portion 52a to be more inclined. Although not particularly limited thereto, the maximum thickness Tₘₐₓ may be 10 times or less, or 5 times or less the minimum thickness Tₘᵢₙ of the inclined portion 56a in the first protection layer 56.

The maximum thickness Tₘₐₓ of the inclined portion 56a of the first protection layer 56 may be, for example, 30 μm to 80 μm, preferably 40 μm to 60 μm. The minimum thickness Tₘᵢₙ of the inclined portion 56a of the first protection layer 56 is, for example, 5 μm to 30 μm, preferably 10 μm to 20 μm. The average thickness of the inclined portion 56a of the first protection layer 56 may be, for example, 15 μm to 50 μm, preferably 20 μm to 40 μm.

When the distance from the edge side of the positive electrode current collector foil 52 provided with the positive electrode current collector foil exposed portion 52a to the edge side of the positive electrode active material layer 54 on the positive electrode current collector foil exposed portion 52a side in the width direction of the positive electrode current collector foil 52 is 100%, the inclined portion 56a of the first protection layer 56 may be located in range of up to 50%, preferably 30% or less, more preferably 15% or less, yet more preferably 10% or less from the positive electrode active material layer 54 side. In this manner, the inclined portion 56a is provided near the positive electrode active material layer 54. This makes it easier to incline the entire positive electrode current collector foil exposed portion 52a.

In the present embodiment, the first protection layer 56 includes a flat portion 56c. The flat portion 56c extends from the inclined portion 56a toward the positive electrode current collector foil exposed portion 52a, and substantially prevents short circuit between the positive electrode 50 and the negative electrode 60. The average thickness of the flat portion 56c in the first protection layer 56 may be the same as the minimum thickness Tₘᵢₙ of the first protection layer 56 in the inclined portion 56a.

The first protection layer 56 contains a binder. The first protection layer 56 may further contain ceramic particles and an electroconductive material. The first protection layer forming paste is prepared by dispersing the binder and optional components (ceramic particles, an electroconductive material, and the like) in a solvent (e.g., NMP).

Examples of the binder contained in the first protection layer 56 include an acrylic binder, styrene-butadiene rubber (SBR), and a polyolefin-based binder. Alternatively, a fluorine-based polymer such as polyvinylidene fluoride (PVDF) and polytetrafluoroethylene (PTFE) may also be used. Among them, a binder with a high contraction rate, such as PVDF is preferably used in light of easily inclining the positive electrode current collector foil exposed portion 52a.

The proportion of the binder in the entire first protection layer 56 is, for example, 15 mass % or more, preferably 20 mass % or more, yet more preferably 25 mass % or more. The higher the proportion of the binder in the first protection layer 56 is, the higher the force of contraction of the first protection layer forming paste is. This makes it easier to incline the positive electrode current collector foil exposed portion 52a. Although not particularly limited thereto, when the first protection layer 56 contains a component (e.g., ceramic particles, an electroconductive material, or the like) in addition to the binder, the proportion of the binder in the first protection layer 56 may be, for example, 50 mass % or less, 40 mass % or less, or 30 mass % or less. The first protection layer 56 may consist substantially of a binder (i.e., 100 mass % of binder).

Examples of the ceramic particles which may be contained in the first protection layer 56 include: oxide-based ceramic particles such as alumina (Al₂O₃), silica (Sift), titania (TiO₂), zirconia (ZrO₂), magnesia (MgO), ceria (CeO₂), and zinc oxide (ZnO); nitride-based ceramic particles such as silicon nitride, titanium nitride, and boron nitride; hydroxide particles such as calcium hydroxide, magnesium hydroxide, and aluminum hydroxide; and clay mineral particles such as mica, talc, boehmite, zeolite, apatite, and kaolin. Among them, alumina particles and boehmite particles are preferably used. Alumina and boehmite have a high melting point and excellent heat resistance. Alumina and boehmite have a relatively high Mohs hardness and excellent mechanical strength and durability. Alumina and boehmite are relatively inexpensive. Thus, the costs of raw materials can be reduced.

The shape of the ceramic particles is not particularly limited, and may be a spherical shape or a non-spherical shape. The mean particle diameter (D50) of ceramic particles is not particularly limited, and is, for example, 0.01 μm or more to 10 μm or less, preferably 0.1 μm or more to 5 μm or less, more preferably 0.2 μm or more to 2.0 μm or less. The “mean particle diameter” herein is a particle diameter (median diameter: D50) corresponding to the particle diameter at a cumulative value of 50% of fine particle side in the volume-based particle size distribution based on laser diffraction/scattering method. The mean particle diameter can be determined using a commercially available laser diffraction and scattering particle size analyzer.

When the first protection layer 56 contains ceramic particles, the proportion of the ceramic particles in the entire first protection layer 56 is not particularly limited, and may be, for example, 50 mass % or more to 90 mass % or less, preferably 60 mass % or more to 80 mass % or less.

Examples of the electroconductive material contained in the first protection layer 56 include channel black such as acetylene black, furnace black, channel black, thermal black, and ketjen black. When the first protection layer 56 contains an electroconductive material, the current collecting ability of the positive electrode 50 increases.

When the first protection layer 56 contains an electroconductive material, the proportion of the electroconductive material in the entire first protection layer 56 is not particularly limited, and may be, for example, 0.1 mass % or more to 5.0 mass % or less, preferably 0.1 mass % or more to 1.0 mass % or less.

In the present embodiment, as shown in FIG. 3B, the second protection layer 58 is formed on a surface of the positive electrode current collector foil 52, opposite to the surface on which the first protection layer 56 is formed. The second protection layer 58 is formed between the positive electrode active material layer 54 and the positive electrode current collector foil exposed portion 52a. In the present embodiment, the second protection layer 58 is formed adjacent to the positive electrode active material layer 54. In the present embodiment, the second protection layer 58 is formed as a flat layer without an inclined portion, but the shape thereof is not particularly limited.

The components of the second protection layer 58 may be the same as those of the first protection layer 56, and may contain, for example, a binder, ceramic particles, an electroconductive material, and the like.

The average thickness of a portion of the second protection layer 58 (i.e., on the opposite surface of the positive electrode current collector foil 52 at the position of the inclined portion 56a) corresponding to the position of the inclined portion 56a of the first protection layer 56 is preferably smaller than the average thickness of the first protection layer 56 in the inclined portion 56a. That is, the average thickness of the inclined portion 56a of first protection layer 56 is larger than the average thickness of the portion of the second protection layer 58 corresponding to the position of the inclined portion 56a. Accordingly, the force of contraction at the time when the applied first protection layer forming paste is dried is larger than the force of contraction at the time when a second protection layer forming paste applied is dried. Thus, the positive electrode current collector foil exposed portion 52a is easily inclined toward the surface where the first protection layer 56 is formed.

Although not particularly limited thereto, the average thickness of the entire second protection layer 58 may be, for example, 1 μm to 20 μm, preferably 1 μm to 10 μm.

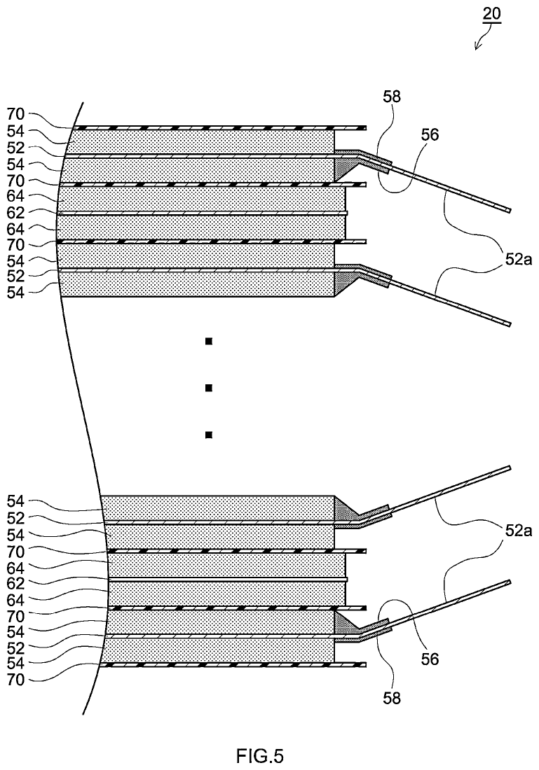

FIG. 5 is a cross-sectional view of a stacking surface of an electrode body 20 (wound electrode body) including the positive electrode 50 according to the embodiment. The positive electrode current collector foil exposed portion 52a is inclined toward the surface where the first protection layer 56 is formed. Thus, a portion of the positive electrode current collector foil exposed portion 52a below the center of the length (height) in the stacking direction is inclined upward, and a portion of the positive electrode current collector foil exposed portion 52a above the center, the positive electrode current collector foil exposed portion 52a is inclined downward. As a result, the positive electrode current collector foil exposed portion 52a is gathered around the center. This makes it easier for multiple positive electrode current collector foil exposed portions 52a stacked to be bundled, and allows a reduction in load on the positive electrode current collector foil exposed portion 52a at the time when the positive electrode current collector foil exposed portion 52a is welded. As a result, wrinkle or breakage of the positive electrode current collector foil exposed portion 52a is reduced.

The configuration of the positive electrode 50 according to the embodiment and the configuration of the battery 100 have been described above. The positive electrode 50 is employed suitably in a lithium-ion secondary battery, and achieves a battery with reduced wrinkle and breakage of the positive electrode current collector foil exposed portion and high quality reliability. The lithium-ion secondary battery can be used for various applications. Specific applications include portable power sources for a personal computer, a mobile electronic device, and a mobile terminal; vehicle device power sources for a hybrid electric vehicle (HEV) and a plug-in hybrid electric vehicle (PHEV); and storage batteries for a small power storage device. Among them, vehicle drive power sources are preferable. Typically, the multiple batteries 100 used may be connected in series and/or parallel to be in an assembled battery.

The battery disclosed herein may also be configured as a coin type battery, a button type battery, a cylindrical battery, or a laminate case type battery. The battery disclosed herein may also be a polymer battery using a polymer electrolyte instead of a nonaqueous electrolyte or a solid electrolyte using a solid electrolyte instead of the same.

Although specific examples of the technology disclosed herein have been described in detail above, they are mere examples and do not limit the appended claims. The technology disclosed herein encompasses various modifications and changes of the specific examples. For example, it is possible to replace partially the embodiments with other aspects, and it is also possible to add other variations to the embodiments. If the technical feature is not described as essential, it can be eliminated, as appropriate.

In the embodiment, a battery 100 including a flat wound electrode body as an example of an electrode body 20 has been described above. However, the battery disclosed herein can be configured as a battery including a stacked electrode body (i.e., an electrode body where multiple positive electrodes and multiple negative electrodes are stacked alternately). A stacked electrode body may include multiple separators, such that each separator is interposed between each positive electrode and each negative electrode, or the positive and negative electrodes may be alternately stacked while one separator is folded back. In the stacked electrode body, the direction of inclination of the positive electrode current collector foil exposed portion 52a of each positive electrode 50 stacked can be determined arbitrary. For example, such as in the wound electrode body shown in FIG. 5, inclined positive electrode current collector foil exposed portions 52a may be disposed so as to be gathered in the center portion. In this case, the positive electrode 50 near the center portion may be a commonly used positive electrode where the positive electrode current collector foil exposed portion 52a is not inclined. Further, the direction in which each positive electrode current collector foil exposed portion 52a is inclined may be unified to one direction, and an electrode body 20 may be configured in combination with the commonly used positive electrode 50 where the positive electrode current collector foil exposed portion 52a is not inclined.

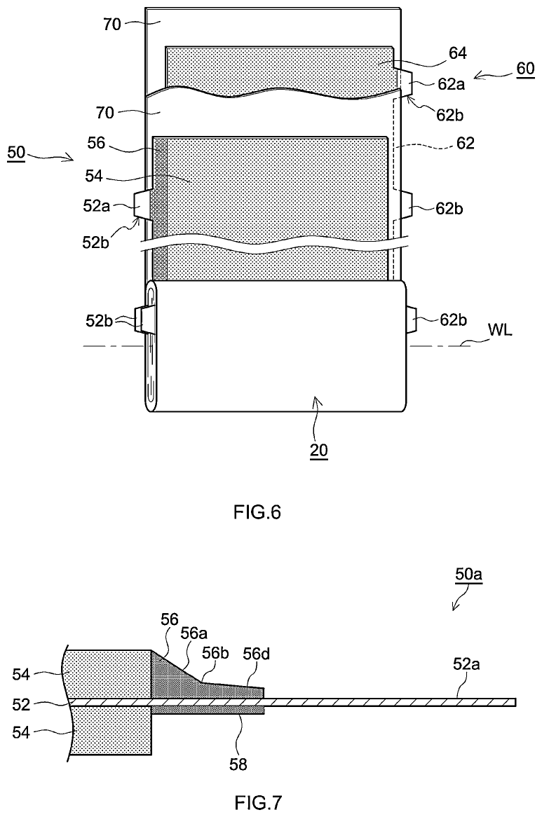

In the present embodiment, as shown in FIG. 2, the positive electrode current collector foil exposed portion 52a is provided in a strip form at one end of the positive electrode current collector foil 52 in the width direction. However, the present disclosure is not limited thereto. For example, as shown in FIG. 6, the positive electrode current collector foil exposed portion 52a is provided on the positive electrode tabs 52b extending from one end of the positive electrode current collector foil 52. The positive electrode tabs 52b may be formed in any shape by cutting the end of the positive electrode current collector foil 52 with laser or the like, for example. The shape of the positive electrode tabs 52b is not particularly limited, and is, for example, a trapezoid. Similarly, for the negative electrode 60, the negative electrode current collector foil exposed portion 62a may be provided on the negative electrode tabs 62b.

In the embodiment, the first protection layer 56 has a flat portion 56c, but the present disclosure is not limited thereto. FIG. 7 is a schematic view of the configuration of the positive electrode 50 according to a first variation, which corresponds to FIG. 3A. For explanation, the positive electrode 50 shown in FIG. 7 shows the state before the positive electrode current collector foil exposed portion 52a is inclined (before drying). In the electrode body 20a, the first protection layer 56 has a second inclined portion 56d instead of the flat portion 56c. The angle of inclination of the second inclined portion 56d to the surface of the positive electrode current collector foil 52 is smaller than the angle of inclination of the inclined portion 56a to the surface of the positive electrode current collector foil 52. With such a configuration, the inclination guiding portion 56b is between the inclined portion 56a and the second inclined portion 56d. With this configuration, by drying the first protection layer forming paste applied, the positive electrode current collector foil exposed portion 52a can be inclined toward the surface where the first protection layer 56 is formed.

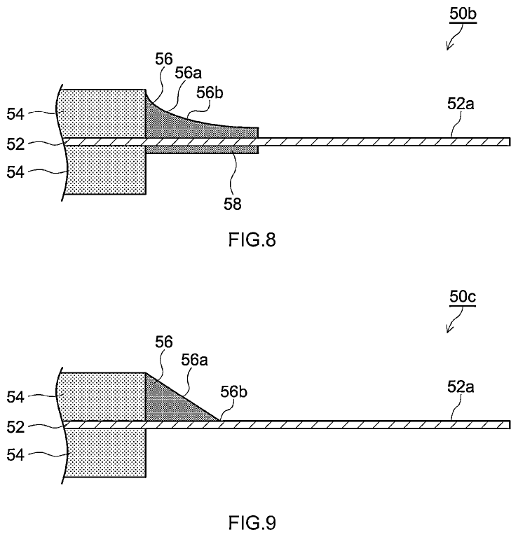

In the embodiment, in the first protection layer 56, the inclined portion 56a has a certain angle of inclination to the surface of the positive electrode current collector foil 52, but the present disclosure is not limited thereto. FIG. 8 is a schematic view of the configuration of the positive electrode 50 according to a second variation, which corresponds to FIG. 3A. For explanation, a positive electrode 50b shown in FIG. 8 shows the state before the positive electrode current collector foil exposed portion 52a is inclined (before drying). In the positive electrode 50, the angle of the inclined portion 56a of the first protection layer 56 to the surface of the positive electrode current collector foil exposed portion 52a decreases from the positive electrode active material layer 54 toward the positive electrode current collector foil exposed portion 52a. Also with such a configuration, when the first protection layer forming paste applied is dried, the force of contraction in a portion of the paste applied with a small thickness has an acute angle to the surface of the positive electrode current collector foil 52. Thus, the positive electrode current collector foil exposed portion 52a can be inclined toward the surface where the first protection layer 56 is formed. With such a configuration, the inclination guiding portion 56b is a part of the inclined portion 56a.

In the embodiment, the first protection layer 56 has a flat portion 56c, but the present disclosure is not limited thereto. FIG. 9 is a schematic view of the configuration of the positive electrode 50 according to a third variation, which corresponds to FIG. 3A. For explanation, a positive electrode 50c shown in FIG. 9 shows the state before the positive electrode current collector foil exposed portion 52a is inclined (before drying). In the positive electrode 50c, the first protection layer 56 does not have a flat portion 56c, and includes an inclined portion 56a having a certain angle of inclination to the surface of the positive electrode current collector foil 52. With such a configuration, the inclination guiding portion 56b is at the end of the inclined portion 56a of the inclination guiding portion 56b, in contact with the positive electrode current collector foil exposed portion 52a. With such a configuration, the positive electrode current collector foil exposed portion 52a can be inclined toward the surface where the first protection layer 56 is formed. In an electrode body 20c, the second protection layer 58 is not formed, and in other embodiments, the second protection layer 58 may be omitted.

What is claimed is:

1. A positive electrode, comprising:
a positive electrode current collector foil;
positive electrode active material layers disposed on both surfaces of the positive electrode current collector foil; and
a first protection layer disposed adjacent to one of the positive electrode active material layers on one surface of the positive electrode current collector foil, wherein
the positive electrode current collector foil has a positive electrode current collector foil exposed portion in which the positive electrode current collector foil is exposed, at least at one end,
the first protection layer is located between the positive electrode current collector foil exposed portion and the positive electrode active material layer,
the first protection layer has an inclined portion,
the inclined portion has a thickness of the first protection layer decreasing from the positive electrode active material layer toward the positive electrode current collector foil exposed portion, and
an angle of the inclined portion to the surface of the positive electrode current collector foil is constant or decreases toward the positive electrode current collector foil exposed portion.

2. The positive electrode according to claim 1, further comprising:
a second protection layer disposed between the positive electrode active material layer and the positive electrode current collector foil exposed portion on a surface of the positive electrode current collector foil opposite to the surface where the first protection layer is located, wherein
an average thickness of the inclined portion of the first protection layer is larger than an average thickness of a portion of the second protection layer corresponding to the position of the inclined portion.

3. The positive electrode according to claim 1, wherein
in a cross section of the first protection layer along an inclination direction of the inclined portion, a maximum thickness Tₘₐₓ of the inclined portion in the first protection layer is two times or more larger than a minimum thickness Tₘᵢₙ of the inclined portion in the first protection layer.

4. An electrode body, comprising:
the positive electrode according to claim 1 and a negative electrode.

5. A battery, comprising:
the electrode body according to claim 4.
